(19) United States
(12) Patent Application Publication
(10) Pub. No.: US 2020/0394203 A1
(43) Pub. Date: Dec. 17, 2020

(54) METHOD AND SYSTEM FOR PROVIDING DATA ANALYTIC SOLUTIONS TO THIRD PARTY ENTITIES

(71) Applicant: IQLECT Software Solutions Pvt. Ltd., Bangalore (IN)

(72) Inventor: Sachin SINHA, Bangalore (IN)

(73) Assignee: IQLECT Software Solutions Pvt. Ltd., Bangalore, OT (IN)

(21) Appl. No.: 16/437,789

(22) Filed: Jun. 11, 2019

(51) Int. Cl. G06F 16/25; G06F 17/27; G06K 9/62; G06N 20/00

(52) U.S. Cl. CPC G06F 16/258; G06F 17/277; G06K 9/6257; G06N 20/00; G06K 9/6263; G06K 9/6231; G06K 9/6227

(57) ABSTRACT

The present disclosure provides a system for providing one or more data analytics solutions to one or more third party entities. The one or more data analytics solutions are provided after extraction of meaningful and organized insights from unstructured data. The extraction is done for conversion of the unstructured data into structured data. The system receives a domain data from the administrator. Further, the system collects a first set of data from one or more sources. Furthermore, the system tokenizes the first set of data into one or more tokens to extract one or more patterns. Moreover, the system re-structures the one or more tokens based on authenticity of the one or more patterns extracted from the one or more tokens. The restructuring of the one or more tokens is performed to convert the unstructured data into the structured data.

### TECHNICAL FIELD

The present disclosure relates to the field of data analytics, and in particular, relates to a method and system for providing data analytic solutions to third party entities.

### INTRODUCTION

Over the past few years, a massive amount of increase in data has been witnessed. The data is generated at a rapid pace every now and then. The data that was earlier generated in a few minutes or hours gets generated within a few milliseconds or less now. The exponential growth in the amount of data being generated is due to increase in usage of computing devices. For an example, the data is generated from RFID tags, sensors, devices, smart watches, cameras, digital devices, e-wallets, and lot more. In addition, rapid advancements in technologies such as machine learning, deep learning, artificial intelligence and the like contribute to the massive amount of increase in the data being generated. However, the massive amount of data generated has to be properly converted into proper format before storing or processing the data. The data may be present in a variety of formats. In addition, the number of formats of the data increases every single day. This, in turn, increases the difficulty in processing and storing of different formats of the data.

### SUMMARY

In a first example, a computer-implemented method is provided. The computer-implemented method provides one or more data analytics solutions to one or more third party entities. The one or more data analytics solutions are provided after extraction of meaningful and organized insights from unstructured data. The extraction is done for conversion of the unstructured data into structured data. The computer-implemented method includes a first step of receiving a domain data from an administrator at a data structuring system with a processor. The computer-implemented method includes another step of collecting a first set of data from one or more sources at the data structuring system with the processor. The computer-implemented method includes yet another step of tokenizing the first set of data into one or more tokens at the data structuring system with the processor. The computer-implemented method includes yet another step of re-structuring the one or more tokens based on authenticity of one or more patterns extracted from the one or more tokens in real-time at the data structuring system with the processor. The domain data includes data associated with domain of interest of the administrator. The domain data is received from the administrator in real-time. The first set of data is collected based on the domain data received from the administrator. The first set of data is collected to train the data structuring system with the domain of interest of the administrator. The data structuring system is trained in a plurality of steps in real-time. The tokenization is performed to extract the one or more patterns from the first set of data. The one or more patterns are extracted using one or more hardware-run pattern recognition algorithms. The restructuring of the one or more tokens is performed based on one or more conditions. The restructuring of the one or more tokens is performed based on an associated confidence level with the one or more patterns extracted from the one or more tokens. The restructuring of the one or more tokens is performed to convert the unstructured data into the structured data.

In an embodiment of the present disclosure, the one or more sources include one of at least an enterprise data source, an application, a third-party database, one or more online knowledgebase, one or more offline knowledgebase, an input device, a scanner, and a hardware computing device.

In an embodiment of the present disclosure, the plurality of steps includes determining sub-domains from the received domain data from the administrator. Further, the plurality of steps includes determining source address of the one or more sources of the first set of data based on the determined sub-domains. Furthermore, the plurality of steps includes generating relevant content from the determined source address of the one or more sources of the first set of data. The sub-domains are determined by the data structuring system. The source address is determined to fetch complete web content from the determined source address of the one or more sources. The relevant content is generated through the data structuring system.

In an embodiment of the present disclosure, the one or more conditions include checking relationship between the one or more tokens, finding conditional dependencies between the one or more tokens and finding associations between the one or more tokens.

In an embodiment of the present disclosure, the first set of data includes complete data collected from the one or more sources based on the received domain data. The first set of data is in one of at least structured or unstructured form.

In an embodiment of the present disclosure, the confidence level associated with the one or more patterns extracted from the one or more tokens is updated in real-time. The confidence level associated with the one or more patterns extracted from the one or more tokens is updated until the confidence level associated with the one or more patterns extracted from the one or more tokens is greater than a threshold confidence level.

In an embodiment of the present disclosure, the administrator is a person that operates and maintains the data structuring system. The administrator is associated with the data structuring system or the one or more third-party entities. The one or more third party entities include one of at least a third-party vendor, third-party solution provider, third-party website, third-party device and third-party application.

In an embodiment of the present disclosure, the one or more data analytics solutions include one of at least adaptive learning, problem control, maintenance, risk analysis, churn analysis, supply chain, marketing, prediction, forecasting, optimization, segmentation, fraud detection, reporting, finance, forensics, statistics, security, and servicing.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for providing one or more data analytics solutions to one or more third party entities. The one or more data analytics solutions are provided after extraction of meaningful and organized insights from unstructured data. The extraction is done for conversion of the unstructured data into structured data. The method includes a first step of receiving a domain data from an administrator at a data structuring system. The method includes another step of collecting a first set of data from one or more sources at the data structuring system. The method includes yet another step of tokenizing the first set of data into one or more tokens at the data structuring system. The method includes yet another step of re-structuring the one or more tokens based on authenticity of one or more patterns extracted from the one or more tokens in real-time at the data structuring system. The domain data includes data associated with domain of interest of the administrator. The domain data is received from the administrator in real-time. The first set of data is collected based on the domain data received from the administrator. The first set of data is collected to train the data structuring system with the domain of interest of the administrator. The data structuring system is trained in a plurality of steps in real-time. The tokenization is performed to extract the one or more patterns from the first set of data. The one or more patterns are extracted using one or more hardware-run pattern recognition algorithms. The restructuring of the one or more tokens is performed based on one or more conditions. The restructuring of the one or more tokens is performed based on an associated confidence level with the one or more patterns extracted from the one or more tokens. The restructuring of the one or more tokens is performed to convert the unstructured data into the structured data.

In an embodiment of the present disclosure, the one or more sources include one of at least an enterprise data source, an application, a third-party database, one or more online knowledgebase, one or more offline knowledgebase, an input device, a scanner, and a hardware computing device.

In an embodiment of the present disclosure, the plurality of steps includes determining sub-domains from the received domain data from the administrator. Further, the plurality of steps includes determining source address of the one or more sources of the first set of data based on the determined sub-domains. Furthermore, the plurality of steps includes generating relevant content from the determined source address of the one or more sources of the first set of data. The sub-domains are determined by the data structuring system. The source address is determined to fetch complete web content from the determined source address of the one or more sources. The relevant content is generated through the data structuring system.

In an embodiment of the present disclosure, the one or more conditions include checking relationship between the one or more tokens, finding conditional dependencies between the one or more tokens and finding associations between the one or more tokens.

In an embodiment of the present disclosure, the first set of data includes complete data collected from the one or more sources based on the received domain data. The first set of data is in one of at least structured or unstructured form.

In an embodiment of the present disclosure, the confidence level associated with the one or more patterns extracted from the one or more tokens is updated in real-time. The confidence level associated with the one or more patterns extracted from the one or more tokens is updated until the confidence level associated with the one or more patterns extracted from the one or more tokens is greater than a threshold confidence level.

In an embodiment of the present disclosure, the administrator is a person that operates and maintains the data structuring system. The administrator is associated with the data structuring system or the one or more third-party entities. The one or more third party entities include one of at least a third-party vendor, third-party solution provider, third-party website, third-party device and third-party application.

In a third example, a non-transitory computer-readable storage medium is provided. The non-transitory computer-readable storage medium encodes computer executable instructions that, when executed by at least one processor, performs a method. The method provides one or more data analytics solutions to one or more third party entities. The one or more data analytics solutions are provided after extraction of meaningful and organized insights from unstructured data. The extraction is done for conversion of the unstructured data into structured data. The method includes a first step of receiving a domain data from an administrator at a computing device. The method includes another step of collecting a first set of data from one or more sources at the computing device. The method includes yet another step of tokenizing the first set of data into one or more tokens at the computing device. The method includes yet another step of re-structuring the one or more tokens based on authenticity of one or more patterns extracted from the one or more tokens in real-time at the computing device. The domain data includes data associated with domain of interest of the administrator. The domain data is received from the administrator in real-time. The first set of data is collected based on the domain data received from the administrator. The first set of data is collected to train the data structuring system with the domain of interest of the administrator. The data structuring system is trained in a plurality of steps in real-time. The tokenization is performed to extract the one or more patterns from the first set of data. The one or more patterns are extracted using one or more hardware-run pattern recognition algorithms. The restructuring of the one or more tokens is performed based on one or more conditions. The restructuring of the one or more tokens is performed based on an associated confidence level with the one or more patterns extracted from the one or more tokens. The restructuring of the one or more tokens is performed to convert the unstructured data into the structured data.

In an embodiment of the present disclosure, the one or more sources include at least an enterprise data source, an application, a third-party database, one or more online knowledgebase, one or more offline knowledgebase, an input device, a scanner, and a hardware computing device.

In an embodiment of the present disclosure, the plurality of steps includes determining sub-domains from the received domain data from the administrator. Further, the plurality of steps includes determining source address of the one or more sources of the first set of data based on the determined sub-domains. Furthermore, the plurality of steps includes generating relevant content from the determined source address of the one or more sources of the first set of data. The sub-domains are determined by the data structuring system. The source address is determined to fetch complete web content from the determined source address of the one or more sources. The relevant content is generated through the data structuring system.

In an embodiment of the present disclosure, the one or more conditions include checking relationship between the one or more tokens, finding conditional dependencies between the one or more tokens and finding associations between the one or more tokens.

In an embodiment of the present disclosure, the confidence level associated with the one or more patterns extracted from the one or more tokens is updated in real-time. The confidence level associated with the one or more patterns extracted from the one or more tokens is updated until the confidence level associated with the one or more patterns extracted from the one or more tokens is greater than a threshold confidence level.

### BRIEF DESCRIPTION OF THE DRAWINGS

Having thus described the invention in general terms, references will now be made to the accompanying figures, wherein:

FIG. 1 illustrates an interactive computing environment for providing one or more data analytic solutions to one or more third party entities, in accordance with various embodiments of the present disclosure;

FIG. 2 illustrates an example of an administrator and a computing device for maintaining the one or more data analytic solutions, in accordance with various embodiments of the present disclosure;

FIG. 3 illustrates a flow chart for providing the one or more data analytic solutions to the one or more third party entities, in accordance with various embodiments of the present disclosure; and

FIG. 4 illustrates a block diagram of a device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

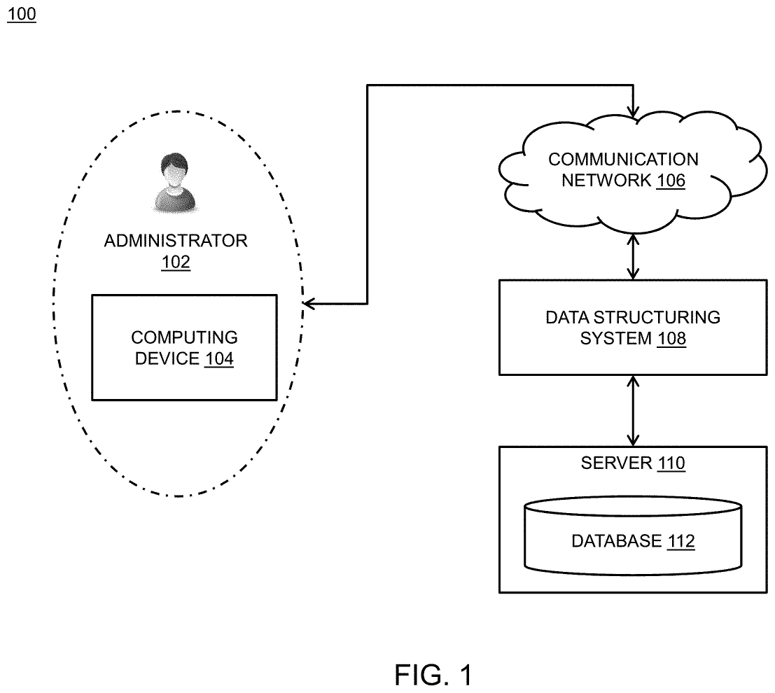

FIG. 1 illustrates an interactive computing environment 100 for providing one or more data analytic solutions to one or more third party entities, in accordance with various embodiments of the present disclosure. The interactive computing environment 100 includes an administrator 102, a computing device 104, a communication network 106, a data structuring system 108, a server 110 and a database 112.

The interactive computing environment 100 includes the administrator 102. The administrator 102 is a person that operates and maintains the data structuring system 108. The administrator 102 is any person that provides reliable and accurate data analytics solutions to the one or more third party entities through the data structuring system 108. In an embodiment of the present disclosure, the administrator 102 is any person that is responsible for upkeep, configuration and reliable operation of the data structuring system 108. In another embodiment of the present disclosure, the administrator 102 is any person that provides reliable and accurate data analytics solutions to the one or more third party entities. In yet another embodiment of the present disclosure, the administrator 102 is any person who installs, maintains and supports the data structuring system 108. In yet another embodiment of the present disclosure, the administrator 102 is any person that troubleshoots or repairs any faults in the data structuring system 108. In yet another embodiment of the present disclosure, the administrator 102 operates and maintains the data structuring system 108 through the computing device 104. The administrator 102 is associated with the data structuring system 108 or the one or more third party entities. Further, the one or more third party entities include one of at least a third-party vendor, third-party solution provider, third-party website, third-party device and third-party application.

The interactive computing environment 100 includes the computing device 104. The computing device 104 is associated with the administrator 102. In an embodiment of the present disclosure, the computing device 104 is used by the administrator 102 to configure and operate the data structuring system 108 at back end. In another embodiment of the present disclosure, the computing device 104 is used by the administrator 102 to maintain and operate the data structuring system 108. In yet another embodiment of the present disclosure, the computing device 104 is used by the administrator 102 to troubleshoot the data structuring system 108. In yet another embodiment of the present disclosure, the computing device 104 is used by the administrator 102 to connect with the data structuring system 108.

In an embodiment of the present disclosure, the computing device 104 is a portable computing device. The portable computing device includes but may not be limited to a laptop, smartphone, tablet, PDA and smart watch. In an example, the smartphone may be an iOS-based smartphone, an Android-based smartphone, a Windows-based smartphone and the like. In another embodiment of the present disclosure, the computing device 104 is a fixed computing device. The fixed computing device includes but may not be limited to desktop, workstation, smart TV and mainframe computer.

In addition, the computing device 104 performs computing operations based on a suitable operating system installed inside the computing device 104. In general, the operating system is system software that manages computer hardware and software resources and provides common services for computer programs. In addition, the operating system acts as an interface for software installed inside the computing device 104 to interact with hardware components of the computing device 104. In an embodiment of the present disclosure, the computing device 104 performs computing operations based on any suitable operating system designed for the portable computing device. In an example, the operating system installed inside the computing device 104 is a mobile operating system. Further, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry, Sailfish from Jolla. However, the operating system is not limited to above mentioned operating systems. In an embodiment of the present disclosure, the computing device 104 operates on any version of particular operating system corresponding to above mentioned operating systems.

In another embodiment of the present disclosure, the computing device 104 performs computing operations based on any suitable operating system designed for fixed computing device. In an example, the operating system installed inside the computing device 104 is Windows from Microsoft. In another example, the operating system installed inside the computing device 104 is Mac from Apple. In yet another example, the operating system installed inside the computing device 104 is Linux based operating system. In yet another example, the operating system installed inside the computing device 104 is Chrome OS from Google. In yet another example, the operating system installed inside the computing device 104 may be one of UNIX, Kali Linux, and the like. However, the operating system is not limited to above mentioned operating systems.

In an embodiment of the present disclosure, the computing device 104 operates on any version of Windows operating system. In another embodiment of the present disclosure, the computing device 104 operates on any version of Mac operating system. In yet another embodiment of the present disclosure, the computing device 104 operates on any version of Linux operating system. In yet another embodiment of the present disclosure, the computing device 104 operates on any version of Chrome OS. In yet another embodiment of the present disclosure, the computing device 104 operates on any version of particular operating system corresponding to above mentioned operating systems.

Further, the interactive computing environment 100 includes the communication network 106. In an embodiment of the present disclosure, the communication network 106 connects the computing device 104 to the data structuring system 108. The computing device 104 of the administrator 102 is connected to the data structuring system 108 through the communication network 106. The communication network 106 provides medium to the computing device 104 to connect to the data structuring system 108. Also, the communication network 106 provides network connectivity to the computing device 104. In an example, the communication network 106 uses a set of protocols to connect the computing device 104 to the data structuring system 108. The communication network 106 connects the computing device 104 to the data structuring system 108 using a plurality of methods. The plurality of methods used to provide network connectivity to the computing device 104 includes 2G, 3G, 4G, 5G, Wifi and the like.

In an embodiment of the present disclosure, the communication network 106 is any type of network that provides internet connectivity to the computing device 104. In an embodiment of the present disclosure, the communication network 106 is wireless mobile network. In another embodiment of the present disclosure, the communication network 106 is wired network with finite bandwidth. In yet another embodiment of the present disclosure, the communication network 106 is combination of the wireless and the wired network for optimum throughput of data transmission. In yet another embodiment of the present disclosure, the communication network 106 is an optical fiber high bandwidth network that enables high data rate with negligible connection drops.

The interactive computing environment 100 includes the data structuring system 108. In an embodiment of the present disclosure, the data structuring system 108 runs on the computing device 104. In another embodiment of the present disclosure, the data structuring system 108 is installed on the computing device 104. In yet another embodiment of the present disclosure, the administrator 102 operates the data structuring system 108 through the computing device 104. In yet another embodiment of the present disclosure, the data structuring system 108 is installed at the server 110. In yet another embodiment of the present disclosure, the data structuring system 108 is installed at a plurality of servers. In an embodiment of the present disclosure, a plurality of servers communicates with each other using the communication network 106. In an example, the plurality of servers may include one of database server, file server, network server, application server and the like.

In an embodiment of the present disclosure, the computing device 104 connects to the data structuring system 108 by utilizing one or more applications. In general, the application is any software code that is programmed to interact with hardware elements of the computing device 104. The term hardware elements include but may not be limited to a plurality of memory types installed inside the computing device 104. Moreover, the application is used to access, read, update and modify data stored in the hardware elements of the computing device 104. Further, the application provides a user interface to the administrator 102 to interact with the hardware elements of the computing device 104. In an example, the user interface may include Graphical User Interface (GUI), command line interface and the like. The user interface helps to send and receive user commands and data. In addition, the user interface serves to display or return results of operation from the application. In an embodiment of the present disclosure, the user interface is part of the application. In an embodiment of the present disclosure, the mobile application installed inside the computing device 104 may be based on any mobile platform.

In another embodiment of the present disclosure, the computing device 104 accesses the data structuring system 108 using a web-based interface. In yet another embodiment of the present disclosure, the data structuring system 108 is accessed through a web browser installed inside the computing device 104. In an example, the web-browser includes but may not be limited to Opera, Mozilla Firefox, Google Chrome, Internet Explorer, Microsoft Edge, Safari and UC Browser. Further, the web browser installed on the computing device 104 runs on any version of the respective web browser of the above mentioned web browsers.

The administrator 102 uses the computing device 104 to operate the data structuring system 108. The data structuring system 108 provides the one or more data analytics solutions to the one or more third party entities. The data structuring system 108 provides the one or more data analytics solutions after extraction of meaningful and organized insights from unstructured data. In general, insights refer to capacity to gain an accurate and deep understanding of someone or something. Further, the extraction is done for conversion of the unstructured data into structured data. The data structuring system 108 receives a domain data from the administrator 102. In an embodiment of the present disclosure, the data structuring system 108 receives the domain data from the one or more third party entities. The data structuring system 108 receives the domain data in real-time. The domain data is received from the administrator 102 in real-time. In an embodiment of the present disclosure, the domain data is received from the one or more third party entities in real-time.

The domain data includes data associated with domain of interest of the administrator 102. In an embodiment of the present disclosure, the domain data includes name of domain for which the administrator 102 wants to receive the one or more data analytics solutions. In another embodiment of the present disclosure, the domain data includes name of domain for which the one or more third party entities want to receive the one or more data analytics solutions. In an example, the domain data includes but may not be limited to communication, security, finance, marketing, medical and telecommunication.

Further, the data structuring system 108 collects a first set of data from one or more sources. The data structuring system 108 collects the first set of data based on the domain data received from the administrator 102. The first set of data includes complete data collected from the one or more sources based on the received domain data. The first set of data collected from the one or more sources is in one of at least structured form or unstructured form. In an embodiment of the present disclosure, the first set of data is in the structured form. In another embodiment of the present disclosure, the first set of data is in the unstructured form. In an example, the first set of data is in form of spreadsheets, database files, emails, documents, text files and the like.

The one or more sources include one of at least an enterprise data source, an application, a third-party database, one or more online knowledgebase, one or more offline knowledgebase and the like. In addition, the enterprise data source contains an enterprise data. In general, the enterprise data is data created by central business processes and stored in enterprise applications. In an example, the enterprise data includes HR data of an enterprise and the like. In an embodiment of the present disclosure, the third-party databases are databases that do not have any direct connection with the data structuring system 108 or the one or more third party entities. In general, the online knowledgebase is a body of questions, answers, documentations, tips and tricks, best practices, knowledge and the like that an enterprise creates, collects and stores online over time. In an example, the one or more online knowledgebase includes but may not be limited to Wikipedia, DBpedia, Canva, Yoast, and Lyft. In general, the offline knowledgebase is a body of questions, answers, documentations, tips and tricks, best practices, knowledge and the like that an enterprise creates, collects and stores offline over time. In an example, the one or more offline knowledgebase includes but may not be limited to an encyclopedia.

In an embodiment of the present disclosure, the one or more sources include an input device. In another embodiment of the present disclosure, the one or more sources include a scanner. In yet another embodiment of the present disclosure, the one or more sources include a hardware computing device. In an example, the input device includes a light pen, a bar code reader (BCR), and the like. In an example, the data structuring system 108 collects the first set of data through the scanner by scanning one or more documents.

In an example, the first set of data includes data from web logs, system log files, RFID tags, social networks, online websites, blogs, call logs and the like. In another example, the first set of data includes but may not be limited to application data, sensor data, customer data, user feedback data, call records, SMS records and Internet search indexing data. In yet another example, the first set of data includes complex data such as military surveillance data, astronomic data, biogeochemical data, genomic data, atmospheric science data, research data and the like.

In an embodiment of the present disclosure, the data structuring system 108 collects the first set of data from the one or more sources using one or more hardware-run information extraction algorithms. In general, Information extraction (hereinafter, IE) is the task of automatically extracting structured information from unstructured and/or semi-structured machine-readable documents. In an example, the data structuring system 108 collects the first set of data from the one or more sources using named entity recognition (hereinafter, NER) algorithms. In general, NER is a subtask of IE that seeks to locate and classify named entities in text into pre-defined categories such as names of persons, organizations, locations, expressions of times, quantities, monetary values, percentages, and the like. In another example, the data structuring system 108 collects the first set of data from the one or more sources using support vector machine algorithms. In yet another example, the data structuring system 108 collects the first set of data from the one or more sources using clustering algorithms.

Moreover, the first set of data is collected to train the data structuring system 108 with the domain of interest of the administrator 102. In an embodiment of the present disclosure, the data structuring system 108 is trained with the domain of interest of the administrator 102 when the administrator 102 provides the domain data to the data structuring system 108. In another embodiment of the present disclosure, the data structuring system 108 is trained with the domain of interest of the one or more third party entities when the one or more third party entities provide the domain data to the data structuring system 108. Also, the data structuring system 108 is trained in a plurality of steps in real-time. Further, the plurality of steps includes an initial step to determine sub-domains from the received domain data from the administrator 102. The data structuring system 108 uses the received domain data to determine the sub-domains of the domain of interest present in the domain data. The sub-domains of the domain of interest are children or parts of the domain of interest present in the domain data. In an example, Network security, Credit security and the like are the sub-domains of the domain Internet security. In another example, Internet security is the sub-domain of the domain Security.

In an embodiment of the present disclosure, the data structuring system 108 determines the sub-domains of the domain of interest from the domain data using one or more hardware-run machine learning algorithms. In an embodiment of the present disclosure, the one or more hardware-run machine learning algorithms include but may not be limited to Support Vector Machines (hereinafter, SVMs) and clustering algorithms. In general, SVMs are supervised learning models with associated learning algorithms that analyze data used for classification and regression analysis. In general, clustering is task of grouping a set of objects in such a way that objects in the same group are more similar to each other than to those in other groups. In an embodiment of the present disclosure, the one or more hardware-run machine learning algorithms may be one of at least supervised machine learning algorithms, unsupervised machine learning algorithms, reinforced machine learning algorithms and the like.

Furthermore, the plurality of steps includes another step to determine source address of the one or more sources of the first set of data. The source address is determined based on the determined sub-domains. In an embodiment of the present disclosure, the data structuring system 108 determines the source address of the one or more sources of the first set of data. Moreover, the source address of the one or more sources of the first set of data is determined to fetch complete web content from the determined source address of the one or more sources. The plurality of steps includes another step to generate relevant content from the determined source address of the one or more sources of the first set of data. The data structuring system 108 generates the relevant content. In an embodiment of the present disclosure, the first set of data is similar to the relevant content generated from the determined source address.

In an example, the administrator 102 provides Internet security as the domain data to the data structuring system 108. The data structuring system 108 applies the hardware-run machine learning algorithms to the domain data to determine the sub-domains of the domain Internet security. The data structuring system 108 determines Network security, Credit security and the like as the sub-domains of the domain Internet Security. Further, the data structuring system 108 determines the source address of the one or more sources of the first set of data. The data structuring system 108 collects the first set of data based on the determined domain of interest of the administrator 102. In addition, the first set of data is collected based on the determined sub-domains of the domain of interest of the administrator 102. The data structuring system 108 determines http://www.wikipedia.com/network-security as the source address of a source of the one or more sources. Further, the data structuring system 108 fetches the complete web content from the determined source address. The data structuring system 108 fetches HTML content, Xml content and the like to fetch the complete web content from the determined source address. Furthermore, the data structuring system 108 generates relevant content from the determined source address. The data structuring system 108 generates content specifically talking about network security as the relevant content from the determined source address.

The data structuring system 108 tokenizes the first set of data into one or more tokens. The data structuring system 108 performs the tokenization to extract one or more patterns from the first set of data. In general, the tokenization is the process of breaking a sequence of strings into pieces in order to identify the smallest individual unit such as words, keywords, phrases, symbols and the like. In an example, if the first set of data is a sentence “Arthur marries Sophia in year 2010”. The tokenization of the sentence in one or more tokens includes “Arthur”, “marries”, “Sophia” and “2007”. The data structuring system 108 perform annotation on the one or more tokens generated after the tokenization of the first set of data. The annotation is done based on seed class which is pre-stored for the data structuring system 108. The seed class corresponds to initial data set for the annotation. The annotation is done based on classification in the seed class. The seed class acts as a reference for the annotation of the one or more tokens of the first set of data. In an example, the annotation of the one or more tokens of the sentence “Arthur marries Sophia in year 2010” is ((“Arthur”, “male name”), (“marries”, “relation”), (“Sophia”, “female name”), (“2010”, “time”)).

In an embodiment of the present disclosure, the data structuring system 108 performs the tokenization to extract the one or more patterns from result of the annotation of the first set of data. The one or more patterns are extracted using one or more hardware-run pattern recognition algorithms. In general, pattern recognition is the automated recognition of patterns and regularities in data. Also, pattern recognition is closely related to artificial intelligence and machine learning, together with applications such as data mining and knowledge discovery in databases (hereinafter, KDD). In an example, the data structuring system 108 performs the tokenization of the first set of data using auto regex techniques. The term regex stands for regular expression. In general, the regular expression defines a search pattern for strings. Also, the regular expression is a special sequence of characters that helps you match or find other strings or sets of strings, using a specialized syntax held in a pattern. In an embodiment of the present disclosure, the tokenization is done by using parsing method for extracting the one or more patterns. In general, the parsing method involves analysis of the one or more tokens of the first set of data based on the grammatical structure of the first set of data. In another embodiment of the present disclosure, the tokenization is done by using one or more past patterns which are stored in the data structuring system 108. The data structuring system 108 re-structures the one or more tokens based on authenticity of the one or more patterns extracted from the one or more tokens in real-time. The data structuring system 108 performs the restructuring of the one or more tokens based on an associated confidence level with the one or more patterns extracted from the one or more tokens. The confidence level corresponds to the measurement of accuracy of the one or more patterns extracted from the one or more tokens. The higher the confidence level of the one or more patterns indicates accurate relation between the one or more tokens with each other which are extracted by the data structuring system 108. In addition, the data structuring system 108 performs the restructuring of the one or more tokens to convert the unstructured data into the structured data. The data structuring system 108 performs the restructuring of the one or more tokens based on one or more conditions. The data structuring system 108 updates the confidence level associated with the one or more patterns extracted from the one or more tokens in real-time. The data structuring system 108 updates the confidence level associated with the one or more patterns extracted from the one or more tokens until the confidence level associated with the one or more patterns extracted from the one or more tokens is greater than a threshold confidence level. In an embodiment of the present disclosure, the data structuring system 108 updates the confidence level of a pattern of the one or more patterns until the confidence level associated with the pattern of the one or more patterns is greater than a threshold value. In addition, the one or more conditions include checking relationship between the one or more tokens, finding conditional dependencies between the one or more tokens, finding associations between the one or more tokens and the like.

In an embodiment of the present disclosure, the data structuring system 108 is trained based on relationship, conditional dependencies, the one or more patterns between the one or more tokens and the like. In an embodiment of the present disclosure, the data structuring system 108 restructures the one or more tokens based on the relationship possible between the one or more tokens. In an example, ‘James’ and ‘Mike’ are considered to be two tokens of the one or more tokens. The relationship existing between the two tokens is considered to be as ‘the son of’. The data structuring system 108 is trained with the relation such as James is the son of Mike. The data structuring system 108 determines that Mike is the son of James is not possible if James is the son of Mike is known. Moreover, the data structuring system 108 determines that the relationship between the two tokens of the one or more tokens is unidirectional. In another example, ‘John’ and ‘Peter’ are considered to be two tokens of the one or more tokens. The relationship existing between the two tokens is considered to be as ‘the friend of’. The data structuring system 108 is trained with the relation such as John is the friend of Peter. The data structuring system 108 determines that Peter is the friend of John is possible even if John is the friend of Peter is known. Moreover, the data structuring system 108 determines that the relationship between the two tokens of the one or more tokens is bidirectional.

In an embodiment of the present disclosure, the data structuring system 108 restructures the one or more tokens based on the conditional dependencies present between the one or more tokens. In an example, a first token of the one or more tokens is considered to be as ‘It is raining cats and dogs today’. Further, a second token of the one or more tokens is considered to be as ‘I can play an outdoor game today’. The data structuring system 108 restructures the one or more tokens and finds the conditional dependencies between the one or more tokens. The data structuring system 108 determines that the first token and the second token cannot be used together as outdoor game cannot be played during rain.

In an embodiment of the present disclosure, the data structuring system 108 finds the conditional dependencies between the one or more tokens to provide feedback. In an example, the first token is considered to be as ‘The student has passed in the examination’. The second token is considered to be as ‘The student has not given the examination’. The data structuring system 108 determines that the first token and the second token cannot be conditionally dependent on each other. Further, the data structuring system 108 restructures the first token and the second token based on the conditional dependency mismatch found between the first token and the second token.

In an embodiment of the present disclosure, the data structuring system 108 uses the one or more conditions to extract the one or more patterns from the first set of data. The data structuring system 108 extracts the one or more patterns based on the relationship between the one or more tokens. In an embodiment of the present disclosure, the data structuring system 108 restructures the one or more tokens based on finding associations between the one or more tokens. In an example, the one or more tokens are restructured based on the association between a first token and a second token of the one or more tokens.

In an embodiment of the present disclosure, the data structuring system 108 updates the confidence level of the one or more tokens based on the one or more conditions between the one or more tokens. The data structuring system 108 updates the confidence level of the one or more tokens based on the one or more conditions found between the one or more tokens in real-time. The data structuring system 108 updates the confidence level of the one or more tokens until the confidence level of the one or more tokens is greater than the threshold value. In an embodiment of the present disclosure, the data structuring system 108 updates the confidence level of the one or more tokens based on restructuring of the one or more tokens in real-time.

The data structuring system 108 restructures the one or more tokens to store the one or more tokens into structured form. The data structuring system 108 converts the unstructured data into the structured data. In an embodiment of the present disclosure, the data structuring system 108 converts unstructured text into structured text. In another embodiment of the present disclosure, the data structuring system 108 includes other formats such as images, audio, video, animations, gifs and the like to convert and store in structured form from unstructured form.

The one or more third party entities are entities that interact with the data structuring system 108 to receive the one or more data analytics solutions. The one or more third party entities include one of at least a third-party vendor, third-party solution provider, third-party website, third-party device, third-party application and the like. The one or more third party entities refer to entities that want to connect with the data structuring system 108. In an embodiment of the present disclosure, the one or more third party entities refer to entities that want to interact with the data structuring system 108. In another embodiment of the present disclosure, the one or more third party entities refer to entities that already interact with the data structuring system 108. In an embodiment of the present disclosure, the data structuring system 108 is integrated with the one or more third party entities. Also, the integration is required to provide the one or more data analytics solutions to the one or more third party entities. Moreover, the one or more data analytics solutions include one of at least adaptive learning, problem control, maintenance, risk analysis, churn analysis, supply chain, marketing, prediction, forecasting, optimization, segmentation, fraud detection, reporting, finance, forensics, statistics, security, servicing and the like. However, the one or more data analytics solutions are not limited to the above mentioned data analytics solutions.

The interactive computing environment 100 includes the server 110. Further, the data structuring system 108 is connected with the server 110. In an embodiment of the present disclosure, the data structuring system 108 runs on the server 110. In another embodiment of the present disclosure, the data structuring system 108 is installed on the server 110. In general, the server 110 is a computer program that provides service to another computer programs. In general, the server 110 may provide various functionalities or services, such as sharing data or resources among multiple clients, performing computation for a client and the like. In an example, the server 110 may be one of at least dedicated server, cloud server, virtual private server and the like. However, the server 110 is not limited to above mentioned servers.

The interactive computing environment 100 includes the database 112. Furthermore, the database 112 is associated with the server 110. In general, the database 112 is a collection of information that is organized so that it can be easily accessed, managed and updated. The database 112 provides storage location to the domain data, the first set of data and the like. In an embodiment of the present disclosure, the database 112 provides storage location to all the data and information required by the data structuring system 108. In an embodiment of the present disclosure, the database 112 may be one of at least hierarchical database, network database, relational database, object-oriented database and the like. However, the database 112 is not limited to the above mentioned databases. In an example, the database 112 is connected with the server 110. The server 110 stores the domain data and the first set of data in the database 112. The server 110 interacts with the database 112 to retrieve the stored data.

In an embodiment of the present disclosure, the data structuring system 108 fetches the first set of data from the one or more sources up to n amount of degree. In an embodiment of the present disclosure, the n amount of degree refers to hierarchy or level up to which the data structuring system 108 fetches the first set of data. In another embodiment of the present disclosure, the n amount of degree refers to hierarchy or level of sub-domains of the domain of interest up to which the data structuring system 108 fetches the first set of data. In an embodiment of the present disclosure, the administrator 102 provides the value of n amount of degree to the data structuring system 108. In another embodiment of the present disclosure, the one or more third party entities provide the value of n amount of degree to the data structuring system 108. In yet another embodiment of the present disclosure, the value of n amount of degree is provided by default. In an example, the domain Security has the sub-domain as Internet Security. Further, the sub-domain Internet security has sub-domains such as Network security, credit security, and the like. The value of n amount of degree is set as two as the domain is divided up to two levels of hierarchy.

In an embodiment of the present disclosure, the data structuring system 108 fetches the first set of data from the one or more sources in one or more languages. The data structuring system 108 converts the unstructured data into the structured data even when the first set of data is in the one or more languages. In an example, first source of the one or more sources of the first set of data is written in English language. The second source of the one or more sources of the first set of data is written in Hindi language. The third source of the one or more sources of the first set of data is written in German language. The data structuring system 108 converts the unstructured data in a language of the one or more languages into the structured data in the language of the one or more languages.

In an embodiment of the present disclosure, the data structuring system 108 structures the unstructured data and convert it into different language. In an example, the unstructured data fetched from the one or more sources is in English language. The data structuring system 108 converts the unstructured data into the structured data in Hindi language. In another example, the unstructured data fetched from the one or more sources is in German language. The data structuring system 108 converts and structures the unstructured data into the structured data in English language.

It is shown in FIG. 1 that the administrator 102 uses the computing device 104 to operate and maintain the data structuring system 108; however, those skilled in the art would appreciate that there may be more number of the administrators using more number of the computing devices.

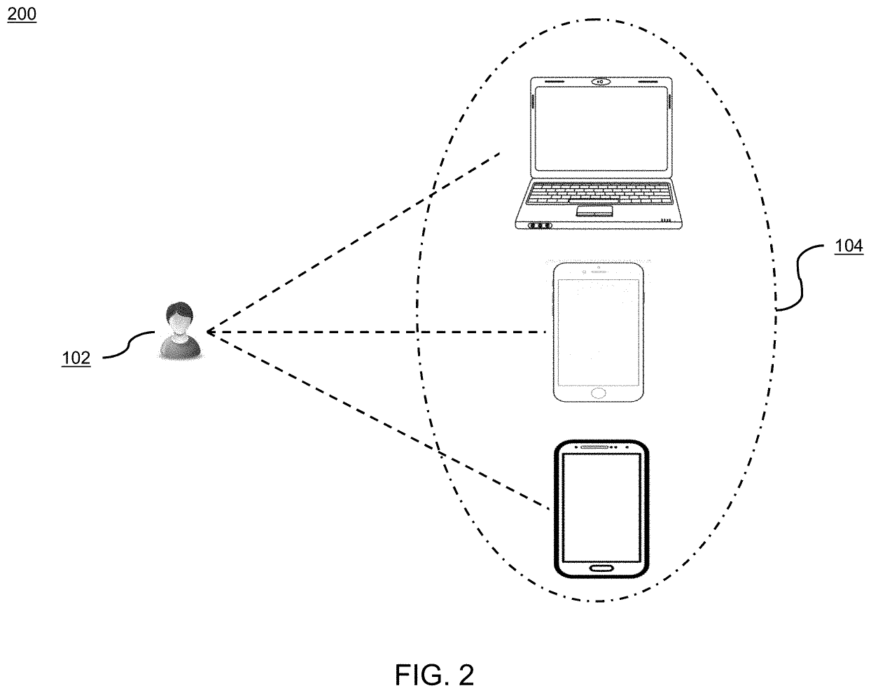

FIG. 2 illustrates an example 200 of the administrator 102 and the computing device 104 for maintaining the one or more data analytic solutions, in accordance with various embodiments of the present disclosure. The administrator 102 uses the computing device 104 to maintain and operate the data structuring system 108. In an example, the computing device 104 is laptop. In another example, the computing device 104 is an iOS-based smartphone. In yet another example, the computing device 104 is an Android-based smartphone.

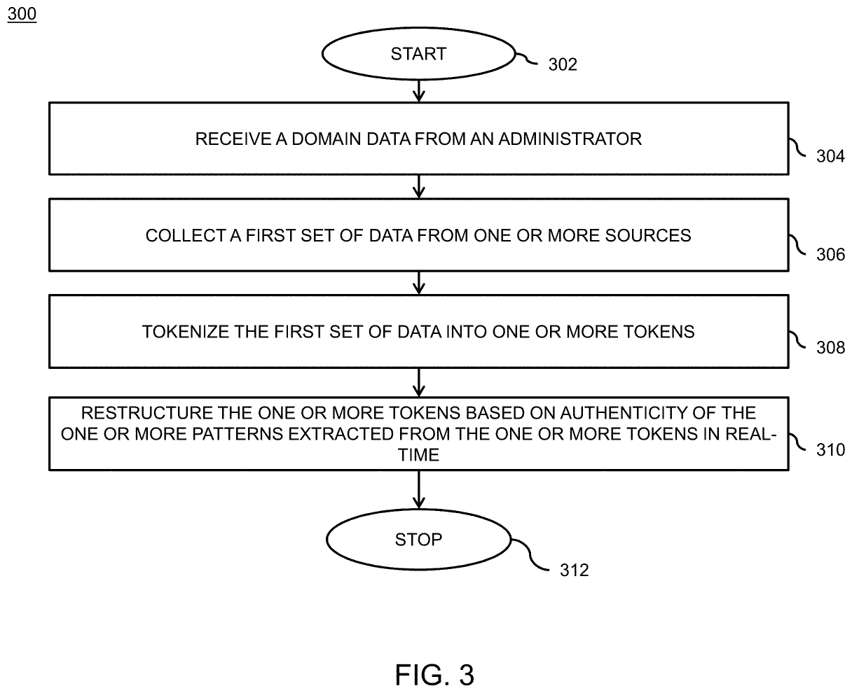

FIG. 3 illustrates a flow chart 300 of a method for providing the one or more data analytic solutions to the one or more third party entities, in accordance with various embodiments of the present disclosure. It may be noted that to explain the process steps of the flowchart 300, references will be made to the system elements of FIG. 1. It may also be noted that the flowchart 300 may have lesser or more number of steps.

The flowchart 300 initiates at step 302. Following step 302, at step 304, the data structuring system 108 receives the domain data from the administrator 102. At step 306, the data structuring system 108 collects the first set of data from one or more sources. At step 308, the data structuring system 108 tokenizes the first set of data into the one or more tokens. At step 310, the data structuring system 108 re-structures the one or more tokens based on authenticity of the one or more patterns extracted from the one or more tokens in real-time. The flow chart 300 terminates at step 312.

The data structuring system 108 may be implemented using a single computing device, or a network of computing devices, including cloud-based computer implementations. The computing devices are preferably server class computers including one or more high-performance computer processors and random access memory, and running an operating system such as LINUX or variants thereof. The operations of the data structuring system 108 as described herein can be controlled through either hardware or through computer programs installed in non-transitory computer readable storage devices such as solid state drives or magnetic storage devices and executed by the processors to perform the functions described herein. The database 112 is implemented using non-transitory computer readable storage devices, and suitable database management systems for data access and retrieval. The data structuring system 108 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

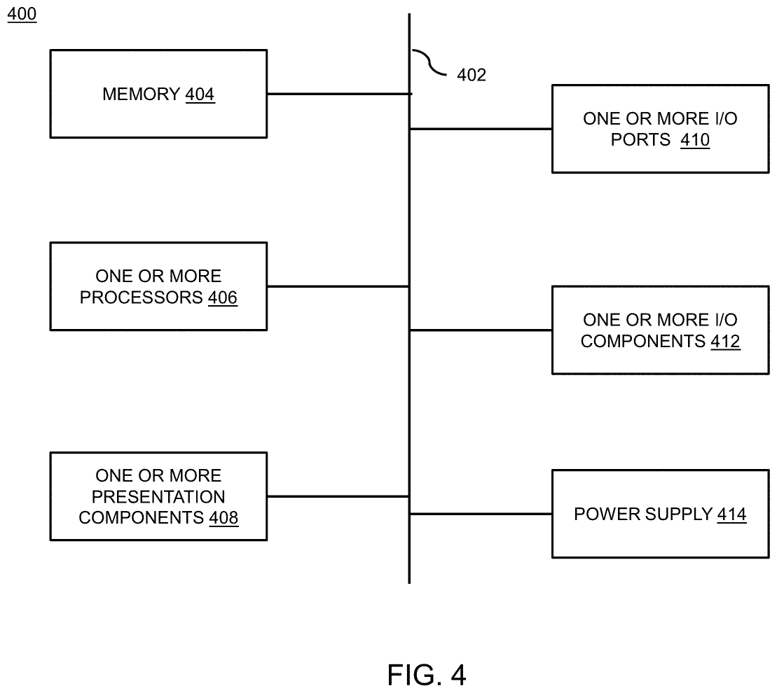

FIG. 4 illustrates a block diagram of a computing device 400, in accordance with various embodiments of the present disclosure. FIG. 4 illustrates internal structural overview of the computing device 104. The device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The device 400 typically includes a variety of computer-readable media. The computer-readable media can be any available media that can be accessed by the device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the device 400. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The device 400 includes the one or more processors 406 that read data from various entities such as memory 404 or I/O components 412. The one or more presentation components 408 present data indications to a user or other device. Exemplary presentation components include a display device, speaker, printing component, vibrating component, etc. The one or more I/O ports 410 allow the device 400 to be logically coupled to other devices including the one or more I/O components 412, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for providing one or more data analytics solutions to one or more third party entities, wherein the one or more data analytics solutions are provided after extraction of meaningful and organized insights from unstructured data, wherein the extraction is done for conversion of the unstructured data into structured data, the computer-implemented method comprising:
receiving, at a data structuring system with a processor, a domain data from an administrator, wherein the domain data comprises data associated with domain of interest of the administrator, wherein the domain data is received from the administrator in real-time;
collecting, at the data structuring system with the processor, a first set of data from one or more sources, wherein the first set of data is collected based on the domain data received from the administrator, wherein the first set of data is collected to train the data structuring system with the domain of interest of the administrator, wherein the data structuring system is trained in a plurality of steps in real-time;
tokenizing, at the data structuring system with the processor, the first set of data into one or more tokens, wherein the tokenization is performed to extract one or more patterns from the first set of data, wherein the one or more patterns are extracted using one or more hardware-run pattern recognition algorithms; and
re-structuring, at the data structuring system with the processor, the one or more tokens based on authenticity of the one or more patterns extracted from the one or more tokens in real-time, wherein the restructuring of the one or more tokens is performed based on one or more conditions, wherein the restructuring of the one or more tokens is performed based on an associated confidence level with the one or more patterns extracted from the one or more tokens, wherein the restructuring of the one or more tokens is performed to convert the unstructured data into the structured data.

2. The computer-implemented method as recited in claim 1, wherein the one or more sources comprising one of at least an enterprise data source, an application, a third-party database, one or more online knowledgebase, one or more offline knowledgebase, an input device, a scanner, and a hardware computing device.

3. The computer-implemented method as recited in claim 1, wherein the plurality of steps further comprising:
determining sub-domains from the received domain data from the administrator, wherein the sub-domains are determined by the data structuring system;
determining source address of the one or more sources of the first set of data based on the determined sub-domains, wherein the source address is determined to fetch complete web content from the determined source address of the one or more sources; and
generating relevant content from the determined source address of the one or more sources of the first set of data, wherein the relevant content is generated through the data structuring system.

4. The computer-implemented method as recited in claim 1, wherein the one or more conditions comprising checking relationship between the one or more tokens, finding conditional dependencies between the one or more tokens and finding associations between the one or more tokens.

5. The computer-implemented method as recited in claim 1, wherein the first set of data comprising complete data collected from the one or more sources based on the received domain data, wherein the first set of data is in one of at least structured or unstructured form.

6. The computer-implemented method as recited in claim 1, wherein the confidence level associated with the one or more patterns extracted from the one or more tokens is updated in real-time, wherein the confidence level associated with the one or more patterns extracted from the one or more tokens is updated until the confidence level associated with the one or more patterns extracted from the one or more tokens is greater than a threshold confidence level.

7. The computer-implemented method as recited in claim 1, wherein the administrator is a person that operates and maintains the data structuring system, wherein the administrator is associated with the data structuring system or the one or more third party entities, wherein the one or more third party entities comprising one of at least a third-party vendor, third-party solution provider, third-party website, third-party device and third-party application.

8. The computer-implemented method as recited in claim 1, wherein the one or more data analytics solutions comprising one of at least adaptive learning, problem control, maintenance, risk analysis, churn analysis, supply chain, marketing, prediction, forecasting, optimization, segmentation, fraud detection, reporting, finance, forensics, statistics, security, and servicing.

9. A computer system comprising:
one or more processors; and
a memory coupled to the one or more processors, the memory for storing instructions which, when executed by the one or more processors, cause the one or more processors to perform a method for providing one or more data analytics solutions to one or more third party entities, wherein the one or more data analytics solutions are provided after extraction of meaningful and organized insights from unstructured data, wherein the extraction is done for conversion of the unstructured data into structured data, the method comprising:
receiving, at a data structuring system, a domain data from an administrator, wherein the domain data comprises data associated with domain of interest of the administrator, wherein the domain data is received from the administrator in real-time;
collecting, at the data structuring system, a first set of data from one or more sources, wherein the first set of data is collected based on the domain data received from the administrator, wherein the first set of data is collected to train the data structuring system with the domain of interest of the administrator, wherein the data structuring system is trained in a plurality of steps in real-time;
tokenizing, at the data structuring system, the first set of data into one or more tokens, wherein the tokenization is performed to extract one or more patterns from the first set of data, wherein the one or more patterns are extracted using one or more hardware-run pattern recognition algorithms; and
re-structuring, at the data structuring system, the one or more tokens based on authenticity of the one or more patterns extracted from the one or more tokens in real-time, wherein the restructuring of the one or more tokens is performed based on one or more conditions, wherein the restructuring of the one or more tokens is performed based on an associated confidence level with the one or more patterns extracted from the one or more tokens, wherein the restructuring of the one or more tokens is performed to convert the unstructured data into the structured data.

10. The computer system as recited in claim 9, wherein the one or more sources comprising one of at least an enterprise data source, an application, a third-party database, one or more online knowledgebase, one or more offline knowledgebase, an input device, a scanner, and a hardware computing device.

11. The computer system as recited in claim 9, wherein the plurality of steps further comprising:
determining sub-domains from the received domain data from the administrator, wherein the sub-domains are determined by the data structuring system;
determining source address of the one or more sources of the first set of data based on the determined sub-domains, wherein the source address is determined to fetch complete web content from the determined source address of the one or more sources; and
generating relevant content from the determined source address of the one or more sources of the first set of data, wherein the relevant content is generated through the data structuring system.

12. The computer system as recited in claim 9, wherein the one or more conditions comprising checking relationship between the one or more tokens, finding conditional dependencies between the one or more tokens and finding associations between the one or more tokens.

13. The computer system as recited in claim 9, wherein the first set of data comprising complete data collected from the one or more sources based on the received domain data, wherein the first set of data is in one of at least structured or unstructured form.

14. The computer system as recited in claim 9, wherein the confidence level associated with the one or more patterns extracted from the one or more tokens is updated in real-time, wherein the confidence level associated with the one or more patterns extracted from the one or more tokens is updated until the confidence level associated with the one or more patterns extracted from the one or more tokens is greater than a threshold confidence level.

15. The computer system as recited in claim 9, wherein the administrator is a person that operates and maintains the data structuring system, wherein the administrator is associated with the data structuring system or the one or more third party entities, wherein the one or more third party entities comprising one of at least a third-party vendor, third-party solution provider, third-party website, third-party device and third-party application.

16. A non-transitory computer-readable storage medium encoding computer executable instructions that, when executed by at least one processor, performs a method for providing one or more data analytics solutions to one or more third party entities, wherein the one or more data analytics solutions are provided after extraction of meaningful and organized insights from unstructured data, wherein the extraction is done for conversion of the unstructured data into structured data, the method comprising:
receiving, at a computing device, a domain data from an administrator, wherein the domain data comprises data associated with domain of interest of the administrator, wherein the domain data is received from the administrator in real-time;
collecting, at the computing device, a first set of data from one or more sources, wherein the first set of data is collected based on the domain data received from the administrator, wherein the first set of data is collected to train the data structuring system with the domain of interest of the administrator, wherein the data structuring system is trained in a plurality of steps in real-time;
tokenizing, at the computing device, the first set of data into one or more tokens, wherein the tokenization is performed to extract one or more patterns from the first set of data, wherein the one or more patterns are extracted using one or more hardware-run pattern recognition algorithms; and
re-structuring, at the computing device, the one or more tokens based on authenticity of the one or more patterns extracted from the one or more tokens in real-time, wherein the restructuring of the one or more tokens is performed based on one or more conditions, wherein the restructuring of the one or more tokens is performed based on an associated confidence level with the one or more patterns extracted from the one or more tokens, wherein the restructuring of the one or more tokens is performed to convert the unstructured data into the structured data.

17. The non-transitory computer readable storage medium as recited in claim 16, wherein the one or more sources comprising at least an enterprise data source, an application, a third-party database, one or more online knowledgebase, one or more offline knowledgebase, an input device, a scanner, and a hardware computing device.

18. The non-transitory computer readable storage medium as recited in claim 16, wherein the plurality of steps further comprising:
determining sub-domains from the received domain data from the administrator, wherein the sub-domains are determined by the data structuring system;
determining source address of the one or more sources of the first set of data based on the determined sub-domains, wherein the source address is determined to fetch complete web content from the determined source address of the one or more sources; and
generating relevant content from the determined source address of the one or more sources of the first set of data, wherein the relevant content is generated through the data structuring system.

19. The non-transitory computer readable storage medium as recited in claim 16, wherein the one or more conditions comprising checking relationship between the one or more tokens, finding conditional dependencies between the one or more tokens and finding associations between the one or more tokens.

20. The non-transitory computer readable storage medium as recited in claim 16, wherein the confidence level associated with the one or more patterns extracted from the one or more tokens is updated in real-time, wherein the confidence level associated with the one or more patterns extracted from the one or more tokens is updated until the confidence level associated with the one or more patterns extracted from the one or more tokens is greater than a threshold confidence level.
